(19) United States
(12) Patent Application Publication
(10) Pub. No.: US 2003/0005326 A1
(43) Pub. Date: Jan. 2, 2003

(54) Method and system for implementing a security application services provider

(76) Inventor: Todd Flemming, Orlando, FL (US)

Correspondence Address: SUGHRUE, MION, ZINN, MACPEAK & SEAS, PLLC, 2100 Pennsylvania Avenue, N.W., Washington, DC, 20037-3213, US

(21) Appl. No.: 09/893,501

(22) Filed: Jun. 29, 2001

(51) Int. Cl. G06F 11/30

(52) U.S. Cl. 713/201

(57) ABSTRACT

An asset protection system and method integrates physical asset security with information asset security in a hosted environment, or in certain circumstances in a users environment, as a security application service provider (SASP). The SASP allows customers to acquire computer-based applications for use in information security and/or asset protection, and have those applications developed, integrated, maintained and/or operated, all in a single location. The hosted environment provides security access, generates reports, triggers alerts, and performs analysis based on usage patterns. Usage patterns of repeat system users are learned, such that an anomalous usage results in corrective action, and include physical entry data, logon and logoff times for various equipment, usage periods and file access for various information technology applications, and ingress/egress operation patterns as viewed from a monitoring device. Additionally, a visitor tracking system permits access to registered visitors having authorization. The registered visitors are authenticated using biometrics.

### BACKGROUND OF THE INVENTION

1. Field of the Invention

The present invention relates to a method and system for an application services provider for security applications, and more specifically, a security application services provider (SASP) that integrates physical security and information security elements and also provides analysis, services, and synergistic alliances.

2. Background of the Prior Art

Prior art physical security systems are fairly simple. For example, a lock on the door has been combined with an electronic security system to protect the perimeter of a building, and lighting has been combined with surveillance by closed circuit television to reduce security problems. Clearly, prior art physical security systems have been very closely related to observable, physical threats.

The introduction of highly automated and networked prior art information technology (IT) environments has made it more difficult to associate responsive and timely mitigation with risk. While intrusion, vandalism, and corporate espionage threats still exist, they are no longer confined to a physical facility, and new cyber based threats exist as well. Because various prior art IT systems to protect either information systems or physical resources are linked electronically, they are more susceptible to cyber risks.

The automation of prior art physical security systems adds to the complexity of the problem. Simple prior art hardware devices such as locks and keys have been replaced by computerized systems operating on public, proprietary or specific use networks. Additionally, as companies have consolidated and streamlined computer systems to take advantage of the economic benefits of common TCP/IP network infrastructures, the existing physical security systems have been placed at risk.

Further, prior art facility control systems are highly reliant on automation controlled by computer applications. For example, companies can secure their customer database using advanced firewalls and encryption, only to have their hard drives stolen by intruders who enter through propped open doors, or when computerized door access systems fail due to security lapses.

Thus, prior art physical and information technology (IT) asset protection systems and the computer applications supporting these systems are not integrated. FIG. 1 illustrates a configuration of a prior art asset protection system. Physical asset protection functions 1a, 1b, 1c involve physical security. For example, but not by way of limitation, a first physical asset protection function 1a may involve building ingress/egress, a second physical asset protection function 1b may involve video camera monitoring, and a third physical asset protection function 1c may involve fire monitoring and/or sprinkler systems.

Further, information asset protection functions 3a, 3b, 3c are unrelated and non-integrated with respect to the physical asset protection functions 1a, 1b, 1c. For example, but not by way of limitation, a first information asset protection function 3a may involve network logon/logoff security, a second information asset protection function 3b may involve firewall control, and a third information asset protection function 3c may involve data encryption and/or employee email control.

However, the prior art asset protection system illustrated in FIG. 1 has various problems and disadvantages. For example, but not by way of limitation, the prior art hosted services do not provide integrated physical and information security access. Controlled access is required for both physical plant and information systems. Thus, an increased cost and risk results, due to the lack of integration and the duplication of effort between physical asset protection and information asset protection.

The aforementioned lack of integration presents additional problems. For physical asset protection functions, access control and intrusion detection are closely intertwined. When a door is forced or propped, the prior art system immediately reacts to this unauthorized entry. However, in the world of Information Technology (IT), access control and intrusion detection are not integrated with physical asset protection. Computer access control presents a barrier (i.e., user logon identification and password) like a lock in the physical world. However, the prior art security server cannot detect the difference between an unauthorized entry and an authorized entry. The hacker, in essence, picks the lock.

Another key difference between the prior art physical and IT asset protection is the nature of access breach. In the physical world, the entry is potentially more quickly detected, and the damage is done in an isolated slice of time that is closely linked to the time of the breach. In the world of IT, access takes the form of permitting a connection. The longer the intruder is connected and goes undetected, the more damage is potentially done. An intruder can remain undetected for an extended period of time. However, the prior art lacks integration between physical and IT asset protection, because of the nature of the intrusion. Prior art integration would be like throwing the deadbolt on a door that had been forced or propped open. Other than a potential entrapment opportunity, there is little benefit in denying access once the breach has occurred as a preventative tool. Thus, the prior art provides no motivation or benefit for integration of physical and IT security.

Additionally, in the prior art system, a breach of physical security will not prevent a breach of information security, and vice versa. For example, but not by way of limitation, a user who breaches an information security asset (e.g., computer hacker) may still enter a building, because the physical security system is not integrated with the information security system. Further, a breach of physical security by a user will not result in the user losing access to information assets. Once a breach occurs, the on-site nature of any non-hosted environment inherently prevents further asset protection once the perpetrator is in control of on-site security.

Additionally, terrorism is increasingly associated with both information assets and critical physical infrastructures. Information asset security problems are rapidly rising. Since terrorism creates chaos to enhance and deliver a message, today's highly networked and computerized critical infrastructure is an ideal target. In many cases, terrorists operate in low risk environments, such as their residences, or live abroad. The prior art non-integrated and non-hosted physical and information asset protection systems cannot cope with those threats.

The prior art system can track viruses, post alerts and warnings, and update a threat database. However, predicting today's threats is as difficult as forecasting a sudden event such as a tornado or earthquake. Although companies recognize that they are vulnerable to such catastrophic events, they do not know exactly when and where they will strike. Also, it is difficult to fully define the threats and associated vulnerabilities and to devise tactics to diminish risks.

Further, prior art visitor management systems cannot provide a detailed level of screening and validation for visitors. For example, but not by way of limitation, because credit reporting typically includes 300 million to 400 million identifiers, the prior art system cannot search for inconsistency in identity information due to the processing requirements on the on-site systems. Accordingly, visitor access is not current or properly monitored, and either too much or too little access is provided. Also, many prior art visitor management systems are limited to sign-in books, as it is physically and financially infeasible to integrate a security system, and the prior art systems do not validate that an authorized person has left a facility or is allowed access to information resources once in a facility. Further, there is no hosted on-line prior art management system for integrated physical security and information security, which also takes into account the possible fraudulent identity of the individual seeking access.

Additionally, a prior art verification system exists that scans a user's image to produce a photo identification that can be used for physical security. However, the prior art verification system has a problem in that it is easy for the user to duplicate the identification using scanners and digitized images. Further, there is no centralized system for verifying whether a user has applied their photograph to a valid user's data. Thus, it is impossible to validate and/or authenticate a user with respect to their security identification. As a result, breach of security occurs.

Asset managers must determine how to arm themselves with effective physical and cyber security risk mitigation responses in an affordable way. Developing, operating and maintaining security applications can be complicated and costly, and security is not the core competency of most businesses. Thus, it is a disadvantage of the prior art that businesses cannot focus the necessary resources to integrate physical and information asset protection on-site.

### SUMMARY OF THE INVENTION

It is an object of the present invention to overcome various problems and disadvantages of the related art.

It is another object of the present invention to provide a physical asset security and information asset security in an integrated form that is seamless to the user.

It is another object of the present invention to provide benefits to the users in the form of more comprehensive security protection for the total environment and to enhance the perception of the user's customers and/or employees with regard to the viability of that environment.

It is yet another object to provide a hosted environment that provides integrated physical and information security, and to make access decisions in accordance with learned usage patterns of asset users.

It is still another object of the present invention to provide the hosted environment in a single location, to develop, maintain, acquire, and/or operate information security and asset protection computer applications for customers.

It is a further object of the present invention to provide analysis and engineering services related to information security and asset protection computer applications.

It is yet another object of the present invention to provide a centrally managed system and method for verifying the authenticity of user credentials, and integrate the verification process with employee and visitor systems for physical security and online security.

It is still another object of the present invention to provide a visitor tracking system that provides integrated physical and information access to users based on initial registration data and user biometrics.

It is still another object of the present invention to provide users access to proprietary computer based applications which can be operated and maintained for the users, that would otherwise not be available.

To achieve the above and other objects, a method of protecting an asset is provided that comprises the step of providing processor-based physical asset protection, providing processor-based information asset protection, and integrating said processor-based physical asset protection and said processor-based information asset protection in a hosted environment.

Further, a system for protecting an asset is provided, comprising a physical asset protection module that provides physical protection for said asset, an information asset protection module that provides information security protection for said asset, and an integrator that performs an integration of said physical asset protection module and said information asset protection module, wherein said system is in a hosted environment.

Additionally, a method of providing asset security protection is provided that comprises transmitting a first signal to a hosted environment, said first signal comprising user registration characteristics, and receiving a second signal from said hosted environment indicative of asset access, wherein protection of physical and information characteristics of said asset is integrated in said hosted environment.

### BRIEF DESCRIPTION OF THE DRAWINGS

The accompanying drawings, which are included to provide a further understanding of preferred embodiments of the present invention and are incorporated in and constitute a part of this specification, illustrate embodiments of the invention and together with the description serve to explain the principles of the drawings.

FIG. 1 illustrates a prior art security service system;

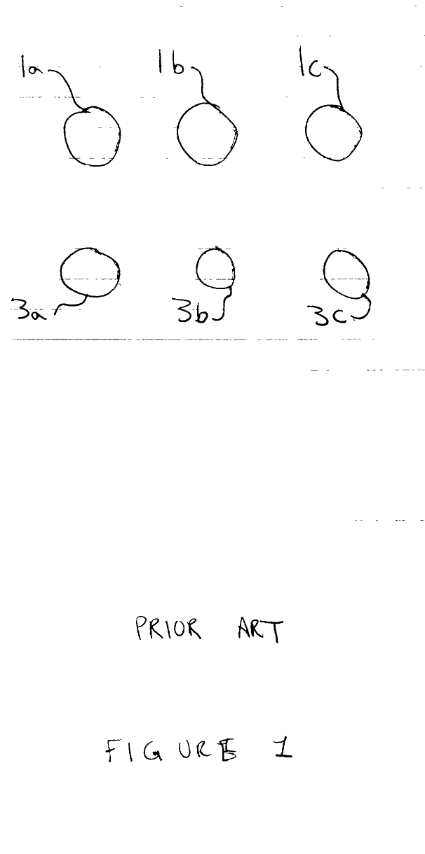

FIG. 2 illustrates a Security Application Services Provider (SASP) system according to a preferred embodiment of the present invention;

FIG. 3 illustrates components of the SASP system according to the preferred embodiment of the present invention;

FIG. 4 illustrates an architecture of the SASP system according to the preferred embodiment of the present invention;

FIG. 5 illustrates a method of performing visitor security according to the preferred embodiment of the present invention; and

FIG. 6 illustrates a method of performing user security according to the preferred embodiment of the present invention;

FIG. 7 illustrates a method of performing identification verification and authentication according to the preferred embodiment of the present invention.

### DETAILED DESCRIPTION OF THE INVENTION

Reference will now be made in detail to the preferred embodiment of the present invention, examples of which are illustrated in the accompanying drawings. In the present invention, the terms are meant to have the definition provided in the specification, and are otherwise not limited by the specification.

Application Service Providers (ASPs) are hosted environment service providers that deliver and manage applications and possibly related computer services from remote data centers for multiple users via the Internet or a network (public or private). An ASP, is a cost-effective solution to the demands of applications ownership and minimizes up-front capital expenses, implementation challenges, and the cost of changes. ASPs give customers a viable alternative to procuring and implementing, and maintain complex applications themselves and could even provide customers with a comprehensive alternative to building and managing internal information technology applications.

The present invention provides a complete, integrated ASP offering physical and information system security for an asset. A full suite, including but not limited to, physical security, visitor tracking, access control, risk assessment, security/penetration testing and disaster planning is provided. For example, but not by way of limitation, all security functions for a given building, or all buildings for a given entity, are combined and consolidated in a hosted environment. The present invention includes an intelligent decision system for physical and information asset control and protection.

The preferred embodiment of the present invention enables a customer to acquire a wide array of computer-based applications (e.g., security software) for use in information security and/or asset protection. The customer can have the software developed, maintained, and/or operated by the Security ASP (SASP). Accordingly, the physical and information asset security protection attributes of security are integrated by the SASP in a single location and in a hosted environment.

In a preferred embodiment of the present invention designed for employee security, building entry with a validation access device (e.g., a card) is provided. An employee can be granted rights to the information systems based on physical access, or independently of physical access. As a result, information system access can be denied based on an employee not being in a physical location, or being denied physical access. Conversely, an individual who unsuccessfully attempts to gain information security access may be denied physical access.

Because different employees may have different work patterns (e.g., some employees work offsite, whereas others work exclusively onsite), the SASP can grant different levels of access to different employees. When an employee attempts to gain access from outside their level of access (e.g., an employee who only works onsite attempts an information security login from an offsite location), the system records that event. Further, the customization of access levels can be validated against a database, as described in greater detail below.

The card is validated upon each entry, and historical usage patterns are generated. Based on the historical usage patterns, the security system provides access to users, and provides alerts when usage anomalies (e.g., login or building entry at a time outside of the use pattern) occur.

In another preferred embodiment of the present invention designed for visitor security, a visitor management system is provided. Each visitor is registered, and then the present system scans the registered visitor against a database that includes the approximately 300 million to 400 million identifiers included in credit reporting information. However, the present invention is not limited thereto, and could include other visitor security criteria. After the database scan has been completed, the visitor arrives at a receiving area (e.g., building receptionist) for additional verification. For example, but not by way of limitation, biometrics verification including information based on user fingerprint or eye image is provided. Then, the visitor is cleared by the third-party database for authentication.

As noted above, different access rights can be granted to different visitors, based on customer request. Further, the access rights can be validated against a database and constantly updated to reflect changes in security access requirements, as discussed in greater detail further below.

An authentication and verification service is also provided in the preferred embodiment of the present invention. The authentication service receives input credentials in the form of photo or biometric identification, digitizes the input credentials and stores those credentials in a hosted environment, and makes the hosted information available for authentication. For example, but not by way of limitation, the hosted information can be printed out as a three-dimensional barcode that can be read by a barcode reader. Thus, a centralized, online authentication system is provided.

The preferred embodiment of the present invention includes an SASP that can offer a seamless blending of physical and information infrastructures security measures, ready access to a full menu of security services and applications, all customization, integration management and operations for all services offerings, all of the ancillary services associated with security to include monitoring and alert notification, and maintains a customer's legacy applications.

The present invention SASP performs, but is not limited to, risk assessments, security tests and evaluations, penetrations testing, and disaster planning in the information security components, and provides the client with an unbiased third party review of products and the application of products. As noted above, the client or customer can acquire the products in a single location from the SASP. Further, the SASP of the present invention acts as a systems integrator to assure its customers that the physical and information security applications will work together and will enhance and not inhibit their business environment.

The preferred embodiment of the present invention also integrates existing systems of building access and computer domain log-on by using the authorization generated by physical access control mechanisms to enable computer domain logons. More specifically, when a user has presented a valid credential to a door controller and has properly entered the building, the preferred embodiment of the present invention permits the computer server to authorize that user to proceed with the normal computer logon by updating the network domain operating system's log-on file with the authorized entry extracted from the building's access control system database.

For example, but not by way of limitation, a valid entry or exit triggers a status change by the SASP on the client's network domain server, such that a valid exit disables computer logons or can cause network disconnection for that user. Upon log-on attempt by a user (valid or invalid), their computer screen will display the user authorization status.

If a user attempts to gain physical access to a door without valid credentials, then the denied entry attempt is logged in the physical access database and reflected in the gatekeeper log files to trigger alarms and/or for later use in forensic study and predictive modeling. Detection and reaction is based on a set of rules consistent with the client's needs and threat levels.

Similarly, if a user attempts to gain access to the computer network without first presenting valid credentials to a door controller, the denied entry attempt is first logged in the network domain server database and reflected in the gatekeeper log files for use in triggering alarms and later study.

As noted above, it is a disadvantage that the prior art system does not validate that an authorized person has left a facility, or is allowed access to information resources once the authorized person has entered or left the facility. The preferred embodiment of the present invention overcomes that disadvantage of the prior art system by continually validating and reviewing personnel access. For example, but not by way of limitation, a personnel access database is updated once an authorized user has left or entered the physical facility, and permits or denies access to information technology in accordance with the updated status of the authorized user. If the user is not authorized to have information asset access once they have left the building, then the database is updated to deny access when the user has not accessed the physical facility.

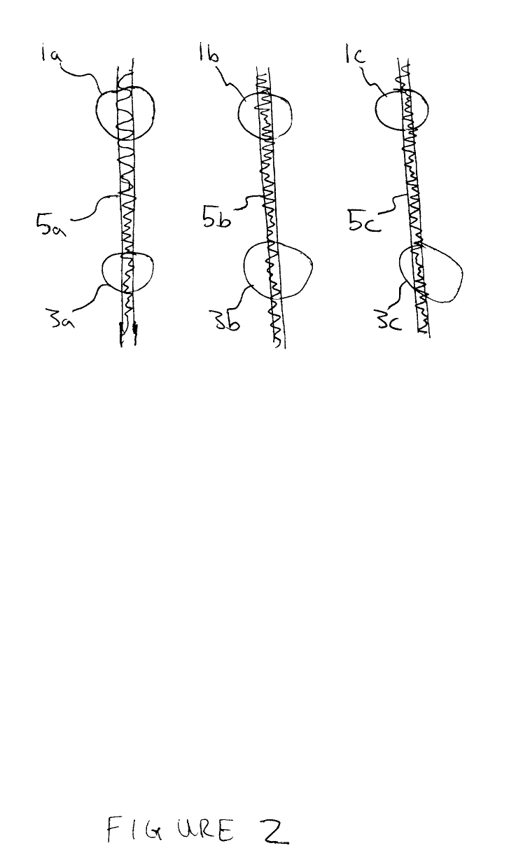

FIG. 2 illustrates the preferred embodiment of the present invention. The physical asset protection functions 1a, 1b, 1c and the information asset protection functions 3a, 3b, 3c are integrated with respect to one another by respective integrating functions 5a, 5b, 5c. The integrating functions are carried out by unique integrated computer applications in a hosted, or customer's, environment, by the Security Application Services Provider (SASP). For example, but not by way of limitation, the SASP integrates physical and information asset protection into a single service hosted by the SASP, and the SASP develops, maintains and operates the single service for the customer or client.

A user of the SASP, includes, but is not limited to, an owner of an asset. For example, but not by way of limitation, the asset may belong to a company, may be an information technology system (e.g., network) located in a physical structure (e.g., office building), a commercial sales building, a customer service area, or any other public or private facility having any information systems in use within or data stored at a physical location. The user of the SASP receives alerts, reports and other status information indicative of physical and information asset protection. Additionally, the information and physical asset protection are integrated, as any breach of physical asset security will result in denial of access to information access security, and vice versa. The hosted SASP also prevents a physical security breach from resulting in an information security breach in the case of an on-site information asset protection system.

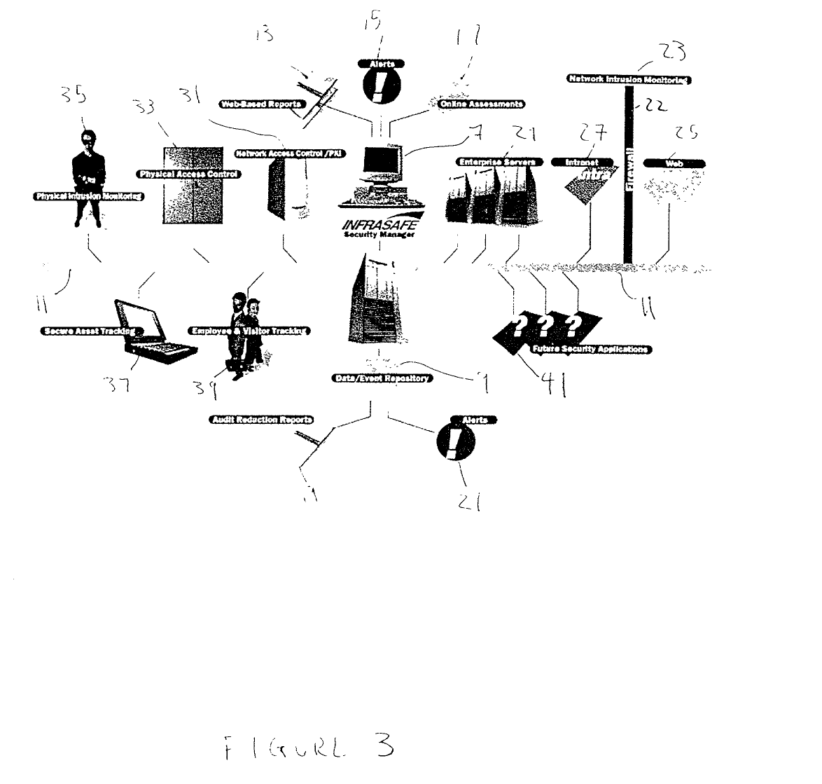

FIG. 3 illustrates various components of the preferred embodiment of the present invention from a user perspective. It is noted that while FIG. 3 provides exemplary embodiments of the present invention, the present invention is not limited thereto.

The SASP 7, which, as noted above, provides for a hosted environment as well as provides the user with the integrated physical and information asset protection. A data storage device 9 is used by SASP personnel to provide and perform analysis and generate alerts 21 and audit reduction reports 19. Further, the SASP 7 provides the user with web-based reports 13, alerts 15 and online assessments 17, based on past and present usage information.

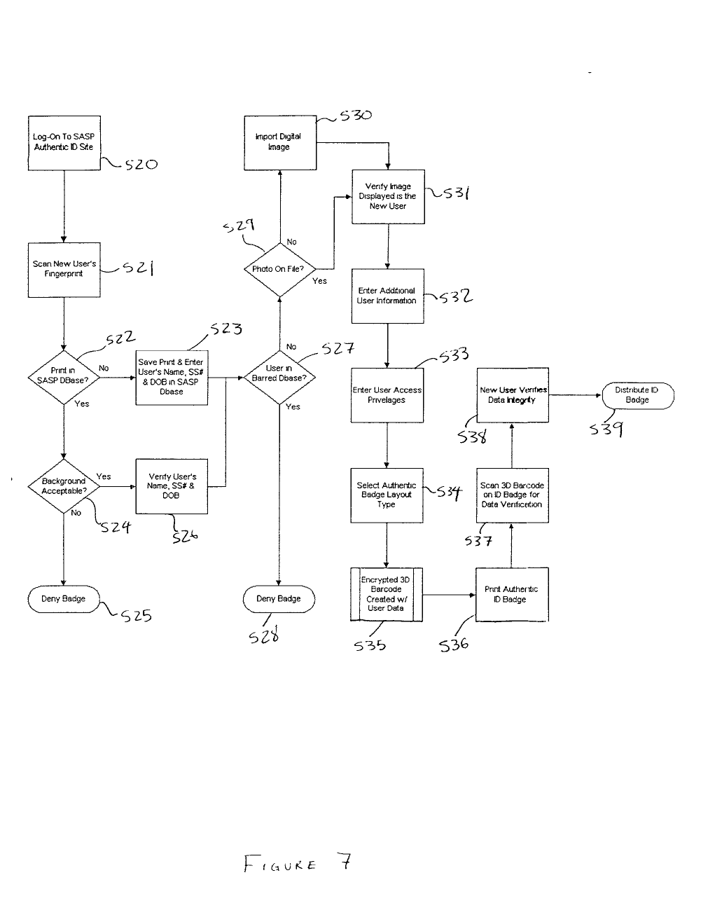

The SASP 7 is coupled to a private network 11, which provides a link between the SASP 7 and the asset. The coupling can be wireless or non-wireless. The SASP 7 protects physical assets by performing physical intrusion monitoring 35 and physical access control 33, as well as network access control 31 (e.g., encryption and email monitoring), secure asset (e.g., laptop) tracking 37, and employee and visitor tracking 39. Additionally, the SASP 7 protects information assets by monitoring and controlling access to enterprise servers 29 and an intranet 27, as illustrated in FIG. 7 and discussed in greater detail below. The SASP 7 also monitors the firewall 22 to detect network intrusion 23, as well as monitor various web functions (e.g., internet access). Additionally, the SASP 7 is modular and scalable in that additional security applications 41 may be easily added to the SASP 7 without substantial modification. The SASP 7 provides the customer with the computer-based applications necessary to implement the preferred embodiments of the present invention, and develops, maintains and operates those applications for the customer, all in a single location.

If physical or information asset security is breached, then the SASP 7 provides an alert 15, 21 to the user. The alert can also include corrective action, such as blocking access for one or more site users from physical access in the case of an information security breach, or vice versa, and the SASP 7 can concurrently provide the asset manager with reports 13, 19 or assessments 17. The SASP provides analysis concerning the alert and actions taken in order to develop mitigation strategies concerning future incidents.

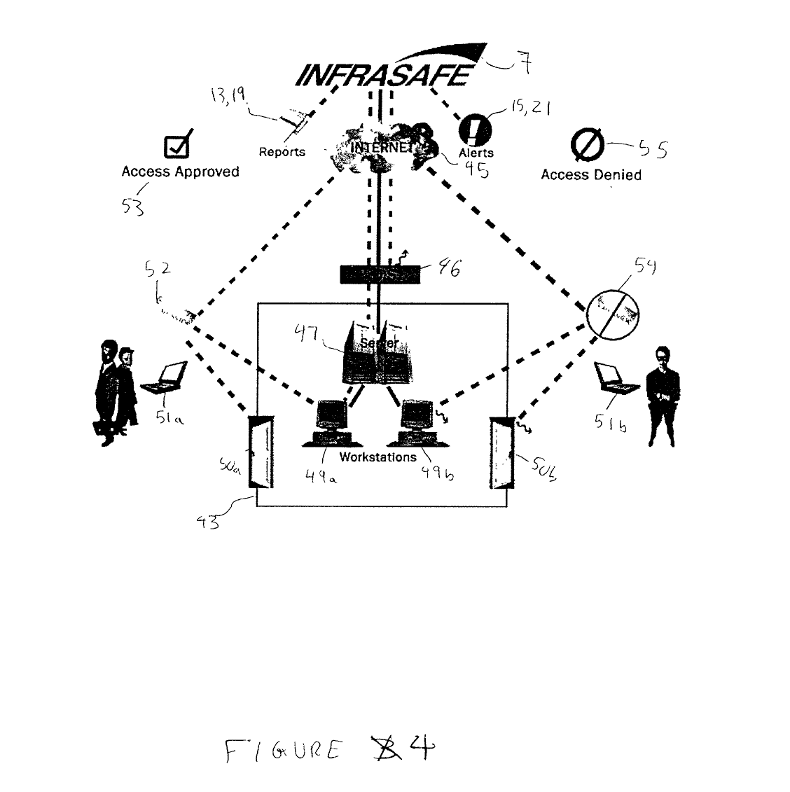

FIG. 4 illustrates the architecture of the preferred embodiment of the present invention. The SASP 7 is connected to the asset 43, via wireless connection (e.g., cellular or satellite) or land line, such that the user can access the SASP 7 via the internet 45. An intrusion detection system 46 is also provided, that is coupled to both the SASP 7 and the asset 43. In this preferred embodiment, the asset 43 includes a server 47, workstations 49a, 49b, and ingress/egress 50a, 50b.

A user can attempt to access the asset 43 with a security-cleared communication device 51a or a non-cleared communication device 51b (e.g., laptop), or alternatively, a valid identification 52 or an invalid identification 54, and accordingly, access will be approved 53 or denied 55. As noted above, the SASP 7 will provide reports 13, 19 and alerts 15, 21, that can be sent to the asset manager, or accessed by the asset manager on the internet 45, and additional corrective action can be taken if appropriate.

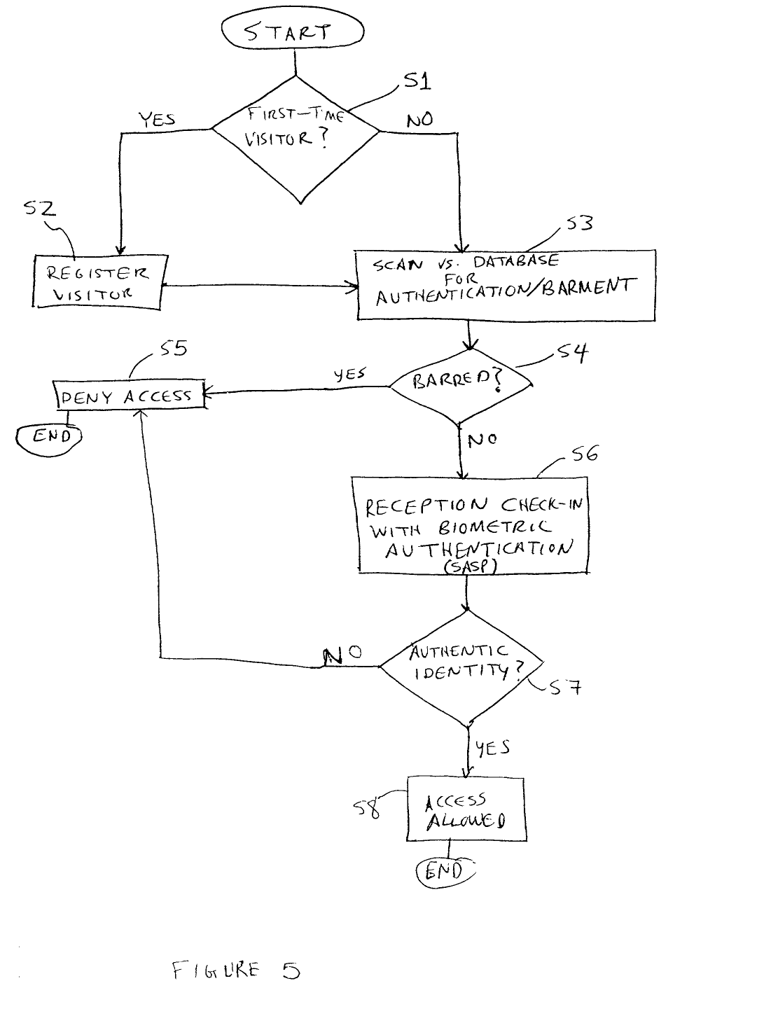

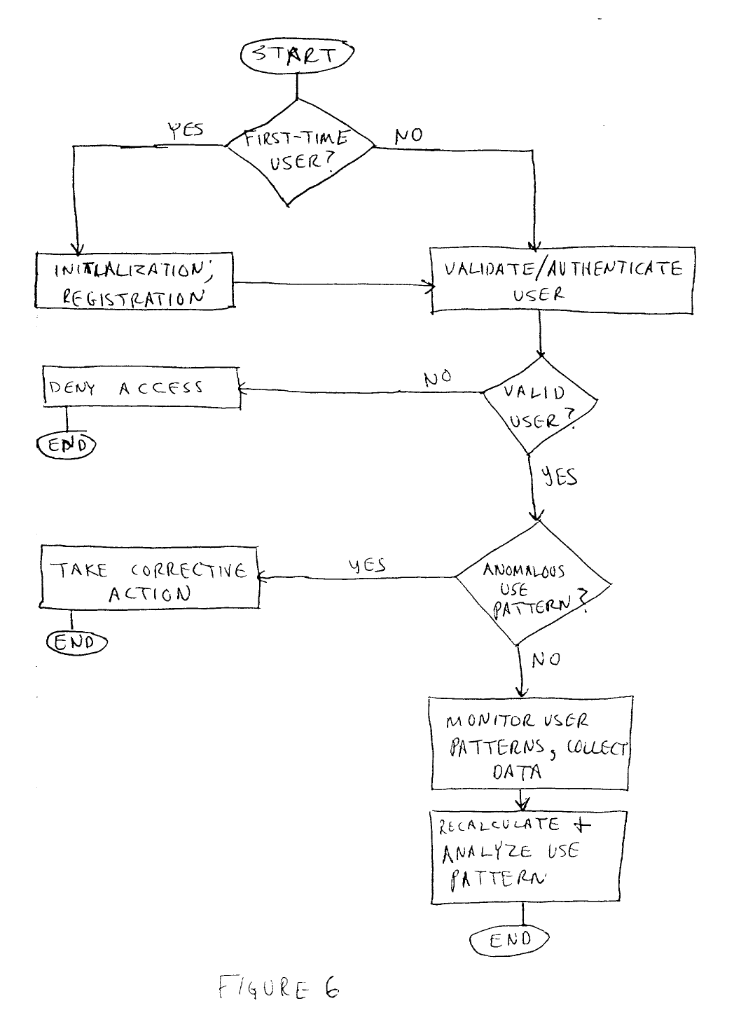

FIGS. 5 and 6 respectively illustrate preferred methods of performing visitor and employee tracking 39 according to the preferred embodiment of the present invention.

FIG. 5 illustrates a visitor monitoring system according to the preferred embodiment of the present invention. In a first step S1, it is determined whether the visitor is a fist time visitor. If the visitor is a first-time visitor, then the visitor is registered in a second step S2. In a third step S3, the information of the registered visitor is scanned against a third-party database that includes information on blacklisted visitors (e.g., barment list), and it is determined whether the visitor is barred in a fourth step S4. If the visitor is barred, then access is denied in a fifth step S5.

If the visitor is not barred, then the visitor proceeds to a check-in area (e.g., receptionist). In the check-in area, an authentication procedure is performed to ensure that the user physically corresponds to the information on the user provided in the registration step S2. Further, additional authentication, including, but not limited to, biometrics is provided. Biometrics can include fingerprints, handprints, or prints based on any feature of the visitor. The SASP then determines whether the identity is authentic S7, and either denies access S5 (i.e., authentication failure) or allows access S8 (i.e., authentication success). Thus, information and physical security is integrated into a single function in the SASP, such that the asset is being protected by a single, integrated, hosted security system.

FIG. 6 illustrates a method of performing personnel tracking according to the preferred embodiment of the present invention. In a first step S9, the system determines whether an employee, visitor, or contractor is a first-time user of the SASP. If the employee is a first-time user, an initialization and registration step S10 is performed, such that user identity information is entered into the SASP, and the user is then registered. The registration process may also include comparing the employee information to information stored in a third-party database to identify any reason for denying access to the employee, visitor, or contractor.

Once the employee, visitor, or contractor who is a first time user has been registered S10, the user is validated and authenticated in a further step S11. In the authentication step S11, the user's information is compared to the third-party database to determine whether the user is valid. The SASP decides S12 whether the user is a valid user. If the user is not a valid user, access is denied S13. If the user is a valid user, the SASP compares the present usage pattern (e.g., entry/exit or login/logout times, applications used, physical areas entered) with historical usage patterns for the present employee in step S14. If an anomaly is detected, the corrective action is taken S15. For example, but not by way of limitation, the corrective may include providing the asset manager with alerts and/or reports, denying access to the employee, or further querying the employee, visitor, or contractor.

If the usage pattern does not indicate an anomaly, usage patterns of the employee are monitored S16 during the usage process, as access is allowed. Once the employee has completed use of the asset and no longer requires access, the SASP analyzes recalculates the employee historical usage pattern, based on the previous historical data and the data collected and analyzed during the most recent use.

For the preferred embodiments of the present invention, the hosted SASP is independent of physical facility, and also independent of operating platform for information system. As noted above, a customer can have the hosted SASP, at a single location, develop, maintain and operate the necessary applications to implement the preferred embodiment of the present invention. Further, the SASP is configured to provide analysis and engineering services related to the information security and physical asset protection functions of the present invention in a single location.

A verification and authentication method system is also provided, and may be integrated with any combination of the aforementioned embodiments (e.g., visitor access and employee access), or implemented as a stand-alone, online (hosted) service. A centralized, commercially managed system validates and authenticates the credentials of users, including, but not limited to, employees and/or visitors. The system may service a plurality of entities (e.g., companies), and may be portable across a company, preferable with the permission of the user. An administrator is capable of authorizing changes to user information, as well as additional and deletions thereto.

In a first phase, a user is enrolled by providing basic biographic information (i.e., credentials), as well as digital and/or biometric information (i.e., validation information). The validation information can include, but is not limited to a digitized photo identification, an e-signature, a fingerprint, a handprint, a 3-D barcode or similar unique identifier information. Accordingly, the user is enrolled, and the user's credentials and validation information are stored in a centrally managed database (e.g., online).

In a second phase, an authorized operator who logs into the centrally managed database can print the user's credentials for authentication. At this point, authentication devices (e.g., fingerprint and/or handprint scanners, 3-D barcode scanner) can be provided. Thus, the operator can verify that the user is who they say they are, and unauthorized access is prevented. If an unauthorized entry is attempted, that entry will be denied.

FIG. 7 illustrates the steps provided in the method of verification and authentication in the preferred embodiment of the present invention. In a first step S20, an authorized operator (e.g., administrator) logs into the SASP to access the authentic identification site. Access to the SASP is limited to prevent unauthorized entry of credentials and/or other validation data. In a following step S21, the administrator enters verification data from the user by performing a validation entry step, such (but not limited to) scanning a new user's fingerprint, hand print eye image or other biometric data, entering a digitized image or electronic signature of the user, or similar verification data entry.

In a next step S22, the SASP determines whether the user verification data has been previously entered into the access database of the SASP. If the validation information has not been entered, the SASP saves the verification data and enters the user's credentials (e.g., name, social security number, and/or date of birth) in the SASP database, at step S23.

If the verification data has already been previously entered, the SASP determines whether the person represented (i.e., user credentials) is acceptable and is authentic in step S24. If the person represented is not acceptable or authentic then access is denied in step S25. However, if the person represented is acceptable and authentic, the user's credentials are verified with the information contained in the SASP database in step S26.

Once the user credentials have been entered or verified, the SASP compares the user information with a barred user database (i.e., a database containing a list of barred users) in step S27, and denies access at step S28 if the current user is on a list of barred users. Denial of access may include, but is not limited to, denial of a security or entry badge, such that the use cannot enter the physical or information system of an entity.

If the user credentials are not in the database of barred users, the SASP determines whether a photo identification is present in the user's hosted file at step S29. If there is no photo in the file, a digital image is imported in step S30. In the following step S31, the SASP verifies that the imported image corresponds to the new user. Once the verification has been completed, additional user information is entered and user access privilege is provide in subsequent steps S32 and S33.

At this point, the SASP has received biometric, photo and biographic data from the new user, and verified that data. The SASP has also confirmed that the new user is not barred from access. If the verification and/or confirmation of whether the user is barred fails, then access has been denied in steps S25 and S28.

At step S34, a badge layout type is selected, and at step S35, the badge is created. For example, but not by way of limitation, the badge may include an encrypted 3D barcode based on the user data received by the SASP. Accordingly, the SASP stores the badge created in step S35. At this point, the user is enrolled.

At any point after enrollment, an authorized operator who is able to access the SASP can reproduce the authentic identification badge for the user. A vinyl printer can be provided to print the badge having a 3D barcode that requires biometric confirmation. For example, but not by way of limitation, the authorized operation can print out the badge only after it the biometric of the user has been scanned to confirm the identity of the user, and biometric scanners can be required at any security point to permit or deny access.

In the second phase, the authentic identification badge is printed in step S36. When the badge is used for access at step S37, the 3D barcode is scanned for data verification. At this point, the verification process can include further scanning of biometric information. At step S38, the new user verifies data integrity, and the identification badge is distributed to the user at step S38. If desired, the badge can have physical or time expiration features that prevent re-use of the badge for a purpose other than its intended purpose.

As noted above, the verification and authentication method of the present invention may be integrated with methods illustrated in FIGS. 5 and/or 6, or may operate independently of those embodiments. Further, the information entered in the centrally managed database may be used for security access control by more than one entity (e.g., employee switches employers and authorizes the SASP to maintain data while switching employer information and building access privileges). If a person is denied building access, then they may also be denied network access.

Other preferred embodiments of the present invention may include, but are not limited to, providing for the development of specialized integrated applications for information and access control as well as the provision of value to existing applications and/or the integration of several applications to provide for a new capability in information and asset protection. Further, additional preferred embodiments may also include information and asset protection applications for value added resale, analytical services associated with the output and performance of information and asset protection applications, technical engineering services associated with studies of technical and physical environments to assess risks and provide for mitigation solutions, and/or engineering services to provide for the implementation of mitigation strategies and devices to protect and environment, or the information technology, physical plant and personnel in that environment.

The present invention has various advantages, and overcomes various problems and disadvantages of the prior art. For example, but not by way of limitation, the present system is facility-independent and platform-independent. Further, the present invention has the advantage of permitting customers to acquire a wide array of computer based applications for use in information security and/or asset protection in a single location. Also, the customer can have the computer based applications developed, maintained or operated by the SASP in a single location. As a result, the customer has a reduced time cost and infrastructure investment, and the functions of IT asset and physical asset protection are integrated so as to reduce the aforementioned disadvantages of the prior art system.

Also, the verification and authentication method of the present invention has various advantages, including but not limited to being portable across companies, vendors, or other entities that require security systems. Additionally, due to the centrally managed, offsite (i.e., hosted) database, theft of identity and unauthorized entry are more difficult. Further, the offsite, online nature of the present invention allows an authorized user to print the badge from any remote location, with only a communication device and badge production device (e.g., printer).

Additionally, the present invention has the advantage of reducing costs of security management by about 30% to 50%. Also, the present invention integrates access protection in both the asset protection and information security worlds and merges with intrusion detection and reaction. The interlinking of all these applications produces improved functionality to each application. Integrated access control as provided in the present invention enables better intrusion detection and activity logs generated by access control and IDS enables quicker and more sensitive reaction. The same activity logs contain robust data that improves forensic study and permits more accurate predictive models. The end result for the client's security is better protection and faster detection.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A method of protecting an asset of an information and/or physical type, comprising the step of:
providing processor-based physical asset protection, providing processor-based information asset protection, and integrating said processor-based physical asset protection and said processor-based information asset protection in a hosted environment.

2. The method of claim 1, said integrating step comprising providing, maintaining and operating a software application that integrates said physical asset protection and said information asset protection in said hosted environment in accordance with user instructions.

3. The method of claim 1, further comprising the steps of:
registering a user by storing user information;
authenticating a user by comparing at least one user characteristic from said user information with a third-party database;
comparing a current asset use pattern with a historical asset use pattern for said user to detect anomalous usage;
updating said historical use pattern on the basis of said current use pattern;
taking a corrective action, wherein a first corrective action is taken if said authenticating step generates a non-authenticated user output and a second corrective action is taken if anomalous usage is detected during said comparing step; and
wherein said authenticating and comparing steps provide physical asset protection and information asset protection and are performed in said hosted environment.

4. The method of claim 3, wherein said corrective action comprises at least one of triggering an alert to a third party, providing a report to an asset manager, logging said non-authenticated user output, disabling network logons, disconnecting other users from said network, and disabling physical access to said asset.

5. The method of claim 1, further comprising the steps of:
registering a visitor by providing initial visitor information;
comparing said initial visitor information with a third-party database to determine if said registered visitor is entitled to access to said asset; and
receiving said registered visitor in an authentication area;
checking a match of said registered visitor with a physical entity;
regulating entry on the basis of said checking and comparing steps, wherein said registered visitor is denied access if said registered visitor does not match said physical entity, or said comparing step indicates that said visitor does not have access to said asset; and
wherein at least one of said comparing step, said receiving step and said checking step provide physical asset protection and information asset protection.

6. The method of claim 5, further comprising one of triggering an alert or a report to an asset manager, logging said non-authenticated user output, disabling network logons, disconnecting other users from said network, and disabling physical access to said asset when said visitor is denied access.

7. The method of claim 5, wherein one of said receiving step and said comparing step comprises applying biometrics to control access for said user.

8. The method of claim 7, wherein said biometrics comprises one of scanning and testing a target tissue of said visitor's body.

9. The method of claim 1, wherein said physical asset protection comprises securing ingress and egress areas for a location protected by a physical barrier.

10. The method of claim 1, further comprising providing an engineering service by collecting and analyzing access information in a data/event repository in said hosted environment that is integrated with an asset environment to perform one of security asset tracking, employee and visitor tracking, physical intrusion monitoring, and network access control and intrusion monitoring.

11. The method of claim 1, further comprising periodically reviewing security information in an access database of said hosted environment to substantially eliminate fraudulent use of said database.

12. A system for protecting an asset, comprising:
a physical asset protection module that provides physical protection for said asset;
an information asset protection module that provides information security protection for said asset; and
an integrator that performs an integration of said physical asset protection module and said information asset protection module, wherein said system is one of in a hosted environment and at said asset.

13. The asset protection system of claim 12, further comprising a user tracking system that authenticates a user as a registered user and provides physical access and information access to said asset in accordance with historical use patterns of said user for said asset, wherein said user tracking system updates said historical use patterns in accordance with a current use pattern of said user.

14. The asset protection system of claim 13, said historical use patterns comprising at least one of frequency, type and time duration.

15. The asset protection system of claim 12, further comprising a visitor tracking system that authenticates a registered visitor that has not been barred from accessing said asset, and allows access in accordance with reception authentication process.

16. The asset protection system of claim 15, further comprising a biometrics authentication subsystem that uses physical data of said visitor to allow said access.

17. The asset protection system of claim 16, wherein said physical data comprises a test data portion of said visitor's body.

18. The asset protection system of claim 12, further comprising a sub-module in said hosted environment, said submodule performing at least one of security asset tracking, employee and visitor tracking, physical intrusion monitoring, network access control and continual monitoring of an access database to substantially eliminate fraudulent use and entry.

19. The asset protection system of claim 12, wherein said integration is performed in response to an instruction to develop, maintain and operate a computer application to protect said asset.

20. A method of providing asset security protection, comprising:
transmitting a first signal to a hosted environment, said first signal comprising user registration characteristics; and
receiving a second signal from said hosted environment indicative of asset access, wherein protection of physical and information characteristics of said asset is integrated in said hosted environment.

21. The method of claim 20, wherein said transmitting step comprises:
providing user registration information to said hosted environment; and
processing at said hosted environment said user information to generate said second signal.

22. The method of claim 20, wherein said receiving step comprises receiving an access decision from said hosted environment, said decision being in accordance with biometrics of a user.

23. The method of claim 20, further comprising comparing said user information to a third-party database to generate an authentication output as said second signal.

24. The method of claim 1, further comprising the steps of:
entering credentials of a user into an access database in said hosted environment to enroll said user; and
outputting an identification object in accordance with said credentials, wherein unauthorized access is denied by said hosted environment.

25. The method of claim 23, said entering step comprising the steps of:
providing an authorized operator with permission to at least one of alter and append said access database;
obtaining a biometric from said user and searching for said biometric in said access database to generate a search result, wherein said biometric and credential data is added to said access database if said search result indicates an absence of said biometric, and if said search result indicates a presence of said biometric in said access database, one of verifying said credential data if said user is authentic and denying access to said user if said user is not authentic, in accordance with said biometric;
denying access to said user if said user appears in a barred user database;
determining if a photo of said user is in said hosted environment, wherein a digital image is imported to generate said photo if said photo is not present in said hosted environment;
verifying that said photo represents said new user;
providing additional user information and user access privileges to said hosted environment; and
generating said identification object having a predetermined layout, said identification object comprising an encrypted three-dimensional barcode in accordance with said biometric and said credential data.

26. The method of claim 23, said outputting step comprising the steps of:
receiving said identification object from said hosted environment and producing a copy of said identification object;
said user verifying integrity of said biometric, said photo and said credentials; and
distributing said identification object to said user.

27. The method of claim 25, wherein said identification object is produced by printing an identification badge.

28. The method of claim 24, wherein said biometric comprises a scan of a biological target tissue.

29. The method of claim 27, wherein said target tissue comprises at least one of finger, hand and eye parameter.
